(19) United States
(12) Patent Application Publication
(10) Pub. No.: US 2026/0268314 A1
(43) Pub. Date: Sep. 10, 2026

(54) DIGITAL ASSET DISTRIBUTION METHOD BASED ON PRIVATE BLOCKCHAIN

(71) Applicant: Kyung Su CHAE, Seogwipo-si, Jeju-do (KR)

(72) Inventor: Kyung Su CHAE, Seogwipo-si, Jeju-do (KR)

(21) Appl. No.: 18/881,576

(22) PCT Filed: Jul. 5, 2023
(86) PCT No.: PCT/KR2023/009456

§ 371 Date: Jan. 6, 2025

(30) Foreign Application Priority Data
Jul. 5, 2022 (KR) 10-2022-0082564

(51) Int. Cl. G06Q 20/38

(52) U.S. Cl. CPC G06Q 20/38215

(57) ABSTRACT

Proposed is a private blockchain-based digital asset distribution method performed by a plurality of nodes constituting a private blockchain. The method includes issuing, by a verifier node, a certificate for trusting a face-to-face digital asset transaction to a first user node through a blockchain network in a certificate issuance step, submitting, by the first user node, transaction statement data about digital assets owned by a first user obtained through short-range wireless communication with a second user node to the blockchain network in a transaction statement submission step, and verifying, by the verifier node, the submitted transaction statement data and applying the same to a distributed ledger in a distributed ledger update step.

### TECHNICAL FIELD

The present disclosure relates to a blockchain. In particular, the present disclosure relates to a blockchain-based digital asset distribution method.

### BACKGROUND ART

Korean Patent No. 10-2273256 discloses BLOCKCHAIN SYSTEM FOR PROOF OF FUTURE VALUE BASED CRYPTO CURRENCY ISSUE AND CIRCULATION AND REWARD ON BASIS OF LEVEL OF CONTRIBUTION TO THE FUTURE VALUE REALIZATION. This system issues coins based on a future value that does not currently exist, but when the value is actually realized, the system distributes results according to the efforts of those who contributed to the realisation.

### DISCLOSURE

### Technical Problem

The present disclosure is directed to providing a new digital asset distribution method based on a private blockchain.

### Technical Solution

According to one aspect, there is provided a private blockchain-based digital asset distribution method performed by a plurality of nodes constituting a private blockchain, the method including: issuing, by a verifier node, a certificate for trusting a face-to-face digital asset transaction to a first user node through a blockchain network in a certificate issuance step; submitting, by the first user node, transaction statement data about digital assets owned by a first user obtained through short-range wireless communication with a second user node to the blockchain network in a transaction statement submission step; and verifying, by the verifier node, the submitted transaction statement data and applying the same to a distributed ledger in a distributed ledger update step.

In the certificate issuance step, the certificate containing the first user's owned digital asset and balance status information may be created, and the created certificate may be encrypted with a private key and then issued to the first user node.

### Advantageous Effects

According to the present disclosure, stable and reliable distribution of digital assets (virtual assets), such as coins or gift certificates, based on a private blockchain can be achieved. In particular, according to the present disclosure, a face-to-face transaction is performed independent of the private blockchain and a result of the transaction is applied to the private blockchain so that distribution of digital assets can be achieved even when a non-face-to-face transaction is impossible or when a face-to-face transaction is required.

### DESCRIPTION OF DRAWINGS

FIG. 1 is a block diagram of a digital asset distribution system based on a private blockchain according to an embodiment.

FIG. 2 is a flowchart of a non-face-to-face digital asset distribution method according to an embodiment.

FIG. 3 is a diagram of an example of a distributed ledger updated according to FIG. 2.

FIG. 4 is a flowchart of a face-to-face digital asset distribution method according to an embodiment.

FIG. 5 is a detailed flowchart of step S210 according to an embodiment.

FIG. 6 is a detailed flowchart of step S210 according to another embodiment.

### BEST MODE

The aforementioned and additional aspects of the present disclosure will become more apparent through exemplary embodiments described with reference to the accompanying drawings. Hereinafter, the present disclosure will be described in detail with reference to the embodiments so that those skilled in the art can easily understand and reproduce the embodiments.

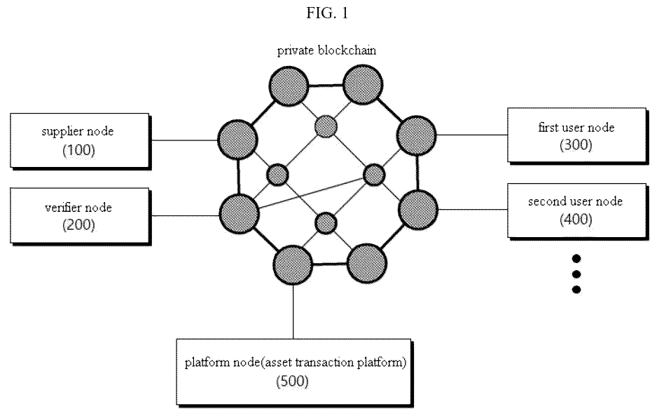

FIG. 1 is a block diagram of a digital asset distribution system based on a private blockchain according to an embodiment. Participant nodes shown in FIG. 1 are devices capable of communication and computing constituting a private network, and divided into a supplier node 100, a verifier node 200, and user nodes 300 and 400 depending on the subject of use or role. The supplier node 100 is a device used by a supplier that initially creates digital assets (digital assets), such as coins or gift certificates, and supplies the same over the private network. For reference, the digital asset may be created by the supplier node 100, or may be created by a separate developer node and provided to the supplier node 100.

The verifier node 200 is a node that performs transaction verification. A verifier node 200 according to an aspect may create a certificate and issue the same to a user, in addition to the general role to verify data to be newly recorded in a distributed ledger. Herein, the certificate is a digital certificate indicating digital assets a user owns and the balance status of the assets. Next, the user nodes 300 and 400 are devices that are used by different users who purchase the digital assets supplied by the supplier or sell the purchased digital assets to another participant (user). Lastly, an asset transaction platform 500 may also be a node constituting the private network, and is an exchange server where digital assets are traded. In addition, a part or all of the supplier node 100, the verifier node 200, and the asset transaction platform 500 among the above-described nodes may be nodes operated by the same operator (for example, an enterprise).

A user application for enabling a user to purchase/sell digital assets is installed on a first user node 300 and a second user node 400 and executed. The user application may be one type of a blockchain application (Bapp), and may have a blockchain wallet function. In addition, the user application may be a Bapp, but also be an extended Bapp with an additional function for face-to-face digital asset transactions independent of the private blockchain. Alternatively, the extension function may be realized as a separate application and may be configured to transmit and receive data, such as certificates and asset transaction statement, to and from the Bapp.

In the meantime, a blockchain is a ledger management technology that involves several nodes that replicate and have data that exist in a chain-like fashion. Participants verify transactions originating from other nodes and combine the transactions to create one block. The created block contains a hash value of the previous block, so changing a particular value of the previous block requires changing the hash values of the previous blocks that the subsequent blocks contain. Therefore, it is impossible for someone to arbitrarily modify and delete data. As blocks are propagated, it may happen that several blocks having different hash values are propagated at the same time. At the moment of occurrence, all the blocks are accepted as normal blocks. However, after some time, among their child blocks, only blocks in a chain leading up to the last block are accepted as normal blocks.

The fact that individual nodes are the main subjects in operation and data is permanently recorded led to its initial focus on electronic commerce, but the advent of Ethereum, a wide variety of tasks can be performed. The Ethereum platform supports the creation and execution of programs called smart contracts. Through a proprietary language called Solidity, contracts that run on the blockchain platform can be developed, and an interface called web3 for executing the contracts on the web or in apps is provided to support users in interacting with each other in a general application program. Since the contracts are executed in the blockchain, the states of the contracts cannot be changed as easily as information recorded on the blockchain. The contracts are Turing-complete, so a desired flow can be written through conditions and repetitions like a general program.

The digital asset distribution system is based on a private blockchain rather than a public blockchain. As is well known, the private blockchain is a blockchain, unlike the public blockchain, which adopts partial centralization and has a subject that reviews the approval process of blocks. This private blockchain is also called a closed blockchain, and transaction statements and behavior are not shared and cannot be tracked except to authorised participants. In addition, private blockchains may include a consortium blockchain. The consortium blockchain is a blockchain in which multiple managment subjects are distributed, and is a form of a private blockchain. Therefore, the digital asset distribution system may be based on the consortium blockchain. In the meantime, in FIG. 1, the supplier node 100 and/or the verifier node 200 may be a subject that reviews whether to approve blocks.

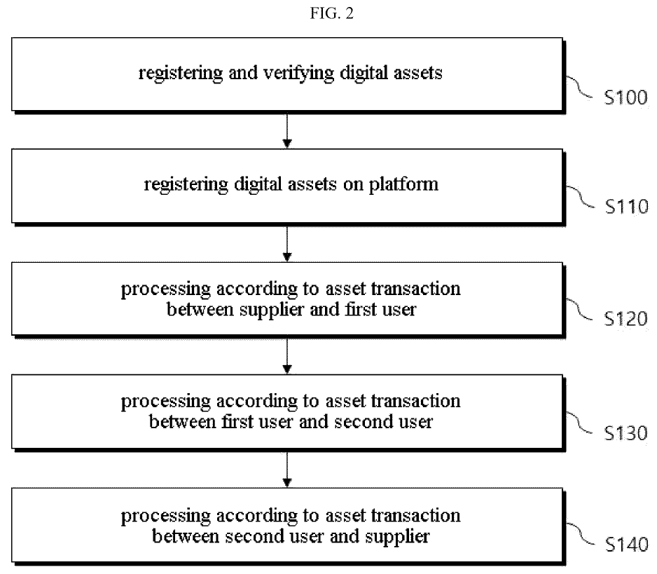

FIG. 2 is a flowchart of a non-face-to-face digital asset distribution method according to an embodiment. Step S100 is a step to create and register digital assets. In step S100, the supplier node 100 creates a distributed ledger based on a private blockchain and digital assets, and stores the created digital assets in a blockchain wallet of the supplier node 100. In addition, the verifier node 200 verifies that the digital assets are owned by the supplier. Specifically, the verifier node 200 receives a copy of the distributed ledger from the supplier node 100 and verifies that the created digital assets are owned by the supplier, thereby ensuring the integrity of information included in blocks.

In addition, the supplier node 100 may also register purchase conditions, such as a list of commodities available for purchase or commodity descriptions, and smart contracts in the distributed ledger in step S100. The purchase conditions are a type of terms and conditions, for example, ‘this digital asset can be exchanged for goods or services worth 100,000 won’. These purchase conditions may include purchase cancellation conditions (refund conditions). In addition, a smart contract means a contract function automatically executed according to fulfilment of conditions, for example, ‘digital assets are transmitted once payment is confirmed’.

Step S110 is an asset registration step. In step S110, a platform node 500 registers digital assets on the asset transaction platform upon request from the supplier node 100, thus enabling asset transactions between participants. That is, participants check and select various coins registered on the exchange (site) that the asset transaction platform provides, and perform transactions.

Steps S120 to S140 each represent an asset transaction between participants. Specifically, step S120 is a step of performing processing according to a digital asset transaction between the supplier (seller) and a first user (purchaser), step S130 is a step of performing processing according to a digital asset transaction between the first user (seller) and a second user (purchaser), and step S140 is a step of performing processing according to a digital asset transaction between the second user (seller) and the supplier.

In step S120, when the first user's purchase transaction for digital assets of the supplier is confirmed, the supplier node 100 updates the distributed ledger and transmits the digital assets to the first user node 300 according to the transaction details, and the first user node 300 stores the transmitted digital assets in the blockchain wallet of the first user. Then, the verifier node 200 verifies the transaction between the supplier and the first user, and updates the distributed ledger according to verification, thereby ensuring the integrity of information contained in blocks.

In step S130, when the second user's purchase transaction for the digital assets of the first user is confirmed, the first user node 300 transmits the digital assets to the second user node 400 according to the transaction details, and the second user node 400 stores the transmitted digital assets in the blockchain wallet of the second user. Then, the supplier node 100 updates the distributed ledger according to the transaction details, and the verifier node 200 verifies the transaction between the first user and the second user and updates the distributed ledger according to verification.

In step S140, when the supplier's purchase transaction for the digital assets of the second user is confirmed, the second user node 400 transmits the digital assets to the supplier node 100 according to the transaction details, and the supplier node 100 updates the distributed ledger according to the transaction details. Then, the supplier node 100 verifies the transaction between the second user and the supplier and updates the distributed ledger according to verification so that the participants are notified that the owner of the digital asset has changed from the second user to the supplier. In addition, for reference, the transaction in step S140 may be an exchange transaction between the digital assets of the second user and the real assets of the supplier.

In the meantime, the expression transmitting digital assets in each step may mean electronical implementation through an application executed in each node. The expression receiving a copy of the distributed ledger does not mean that only the copy of the distributed ledger is received, but for convenience of description, a distributed ledger technology based on a consensus algorithm of the private blockchain is expressed as distributed ledger transmission.

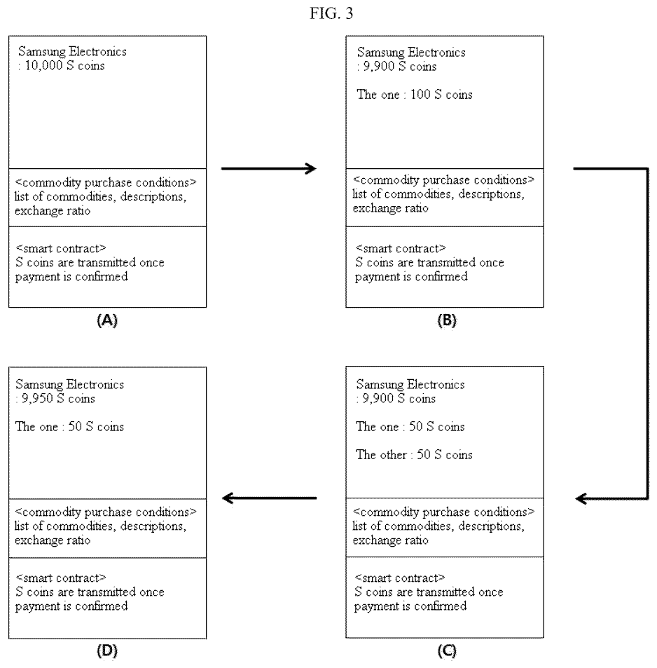

FIG. 3 is a diagram of an example of a distributed ledger updated according to FIG. 2. In the distributed ledger (A) created in step S100, it is recorded that 10000 S coins are owned by Samsung Electronics (supplier). In addition, purchase conditions are registered in the distributed ledger (A), and a smart contract may be registered. In step S120, when a first user (the one) purchases 100 S coins, the distributed ledger (B) is updated to indicate that Samsung Electronics owns 9900 S coins and the owner of 100 S coins has changed from Samsung Electronics to the first user (the one). In step S130, when the second user (the other) purchases 50 S coins from the first user (the one), the distributed ledger (C) is updated to indicate that 9900 S coins are owned by Samsung Electronics, 50 S coins are owned by the first user (the one), and the owner of the remaining 50 S coins has changed from the first user (the one) to the second user (the other). In step S140, when the second user (the other) purchases real assets of Samsung Electronics with 50 S coins, the distributed ledger (D) s updated to indicate the change that Samsung Electronics owns 9950 S coins and 50 S coins of the second user (the other) are deleted. In addition, the above procedures may be automatically executed by the smart contract.

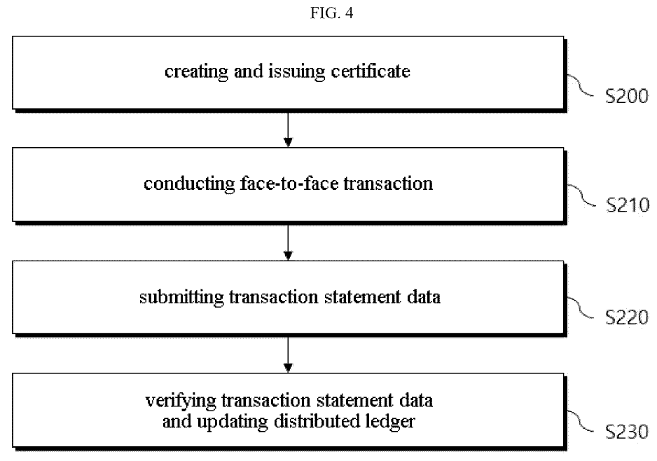

FIG. 4 is a flowchart of a face-to-face digital asset distribution method according to an embodiment. Step S200 is a certificate issuance step. In step S200, the verifier node 200 creates a certificate for the first user who wants to transact with his or her own digital assets, and issues the certificate to the first user node 300. Herein, the verifier node 200 may encrypt the certificate with a private key and issue the encrypted certificate to the first user node 300, and may transmit the certificate together with a public key for decrypting the encrypted certificate to the first user node 300.

In an embodiment, the verifier node 200 creates and issues a certificate when the first user node 300 makes a request for certificate issuance. At the time point of the request, the first user's owned digital assets and balance are checked and recorded in the certificate for issuance. In another embodiment, the verifier node 200 creates and issues certificates periodically of at the time point when each user's digital assets are changed. The certificates issued in step S200 are about digital assets owned by the users, and contain information on which digital assets they are and information on balance statuses.

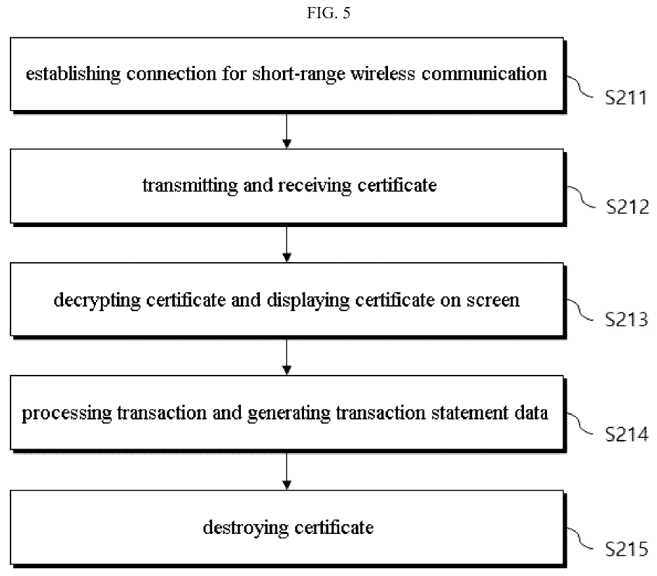

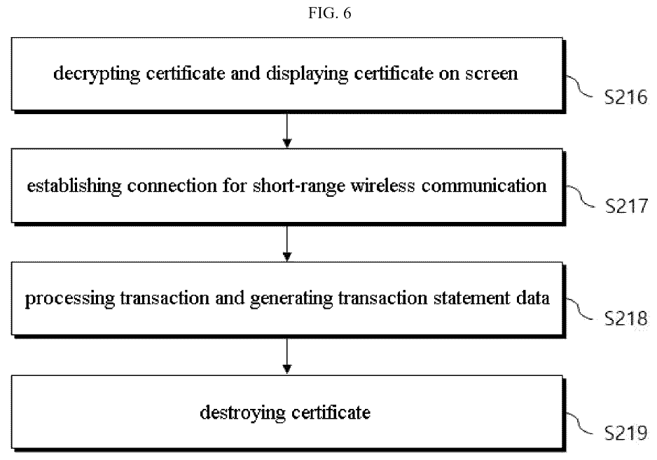

Step S210 is a face-to-face transaction step in which the first user and the second user make a peer-to-peer (P2P) transaction of digital assets over a short distance without using the blockchain network. In step S210, the first user node 300 and the second user node 400 conduct (process) a transaction of the digital assets owned by the first user through short-range wireless communication to generate transaction statement data. Before processing the transaction, the certificate of the first user node 300 is provided to the second user so that the second user is able to trust the transaction with the first user. Specific embodiments of step S210 will be described later with reference to FIGS. 5 and 6.

Step S220 is a transaction statement submission step, and step S230 is a distributed ledger update step. In step S220, the first user node 300 submits transaction statement data obtained in step S210 to the blockchain network. Then, in step S230, the verifier node 200 verifies the transaction statement data and applies the same to the distributed ledger, and the supplier node 100 also applies the transaction statement data to the distributed ledger to complete the update.

Steps S200, S220, and S230 are procedures on the blockchain network, and step S210 is a procedure unrelated to the blockchain network. According to FIG. 4, the first user and second user are able to make transactions of digital assets even in an environment where no online connection is available, and the first user obtains a certificate in advance in an environment where online connection is available before step S210, thereby ensuring the reliability of P2P transactions.

FIG. 5 is a detailed flowchart of step S210 according to an embodiment. The first user node 300 may establish a connection with a wireless channel for short-range wireless communication with the second user node 400 in step S211. Herein, an example of short-range wireless communication may be Bluetooth, but is not limited thereto. When establishment of the connection is completed in step S211, the first user node 300 transmits, to the second user node 400, the encrypted certificate issued from the verifier node 200 and recorded in an internal memory. Then, the second user node 400 receives the certificate from the first user node 300 through the wireless channel in step S212. Herein, a public key may also be transmitted and received with the certificate.

The second user node 400 decrypts the certificate received from the first user node 300 with the public key and displays the decrypted certificate on a screen so that a second participant is able to check the owned assets and balance status information of the first user node 300 and trust the transaction in step S213. After step S213, the first user node 300 processes the transaction of at least a portion of the digital assets of the first user with the second user node 400 through the wireless channel and generates transaction statement data in step S214. Herein, the first user node 300 may perform step S214 only when there is a trust response to the certificate from the second user node 400 through the wireless channel.

Further, when the transaction statement data is generated in step S214, the first user node 300 may destroy the certificate issued from the verifier node 200 in step S215. Since certificate information is no longer correct due to the asset transaction between the first user and the second user, the first user node 300 destroys the certificate to fundamentally prevent the first user from misusing the certificate.

FIG. 6 is a detailed flowchart of step S210 according to another embodiment. The first user node 300 uses the public key to decrypt the encrypted certificate issued from the verifier node 200 and recorded in an internal memory, and displays the decrypted certificate on a screen so that a second user is able to check the certificate through the screen of the first ser node 300 in step S216. That is, the second user checks the digital assets and balance status information of the first user and thus is able to trust transactions. When the second user's trust in the certificate is checked, the first user node 300 may establishment a connection with a wireless channel for short-range wireless communication with the second user node 400 in step S217. When establishment of the connection is completed in step S217, the first user node 300 conducts the transaction of at least a portion of the digital assets of the first user with the second user node 400 through the wireless channel and generates transaction statement data in step S218. Further, when the transaction statement data is generated in step S218, the first user node 300 may destroy the certificate issued from the verifier node 200 in step S219.

In another embodiment, unlike those illustrated in FIGS. 5 and 6, the first user node 300 may update the certificate instead of destroying the certificate after generating the transaction statement data. Specifically, the first user node 300 updates the owned asset and balance status information recorded in the certificate according to the generated transaction statement data. In an embodiment, the first user node 300 decrypts and updates the certificate and then updates the updated certificate with its own private key for storage and management. The reason for updating the certificate rather than destroying the certificate is to enable additional face-to-face transactions. That is, even after an initial face-to-face transaction, the operation shown in FIG. 5 or 6 may be further performed with the updated certificate. Further, the first user node 300 may destroy the certificate after performing step S220.

In the meantime, in certificate encryption/decryption, encryption and decryption may be performed using a technique other than an asymmetric key technique using a private key/public key described above.

The exemplary embodiments of the present disclosure have been particularly described. It will be understood by those skilled in the art that various changes in form are possible without departing from the essential features of the disclosure. Thus, the exemplary embodiments should be considered in a descriptive sense only and not for purposes of limitation. Therefore, the scope of the disclosure is defined not by the detailed description of the disclosure but by the following claims, and all differences within the scope will be construed as being included in the exemplary embodiments.

### Mode for Invention

Various embodiments for carrying out the invention have been described in the best mode for carrying out the invention.

### Industrial Applicability

The present disclosure enables stable and reliable distribution of digital assets, such as coins or gift certificates, based on a private blockchain. In particular, according to the present disclosure, a face-to-face transaction is performed independent of the private blockchain and a result of the transaction is applied to the private blockchain so that distribution of digital assets can be achieved even when a non-face-to-face transaction is impossible or when a face-to-face transaction is required. Accordingly, the present disclosure has industrial applicability.

1. A private blockchain-based digital asset distribution method performed by a plurality of nodes constituting a private blockchain, the method comprising:
issuing, by a verifier node, a certificate for trusting a face-to-face digital asset transaction to a first user node through a blockchain network in a certificate issuance step;
submitting, by the first user node, transaction statement data about digital assets owned by a first user obtained through short-range wireless communication with a second user node to the blockchain network in a transaction statement submission step; and
verifying, by two or more operator nodes including the verifier node, the submitted transaction statement data and applying the same to a distributed ledger in a distributed ledger update step.

2. The method of claim 1, wherein in the certificate issuance step, the certificate containing the first user's owned digital assets and balance status information is created, and the created certificate is encrypted and then issued to the first user node.

3. The method of claim 2, performed between the certificate issuance step and the transaction statement submission step, further comprising:
establishing, by the first user node, a connection with a wireless channel for short-range wireless communication with the second user node;
receiving, by the second user node, the certificate from the first user node through the wireless channel with which the connection is established;
decrypting, by the second user node, the received certificate and displaying the decrypted certificate on a screen to enable a second user to trust the first user's digital assets and balance status information; and
conducting, by the first user node, the transaction of at least a portion of the first user's digital assets with the second user node through the wireless channel and generating the transaction statement data.

4. The method of claim 2, performed between the certificate issuance step and the transaction statement submission step, further comprising:
decrypting, by the first user node, the issued certificate and displaying the decrypted certificate on a screen to enable a second user to check the screen of the first user node and trust the first user's digital assets and balance status information;
establishing, by the first user node, a connection with a wireless channel for short-range wireless communication with the second user node when the second user's trust in the certificate is checked; and
conducting, by the first user node, the transaction of at least a portion of the first user's digital assets with the second user node through the wireless channel and generating the transaction statement data.

5. The method of claim 3, performed between the certificate issuance step and the transaction statement submission step, further comprising:
destroying, by the first user node, the certificate when the transaction statement data is generated.

6. The method of claim 3, further comprising:
updating, by the first user node, the certificate according to the transaction statement data when the transaction statement data is generated.

7. The method of claim 4, performed between the certificate issuance step and the transaction statement submission step, further comprising:
destroying, by the first user node, the certificate when the transaction statement data is generated.

8. The method of claim 4, further comprising:
updating, by the first user node, the certificate according to the transaction statement data when the transaction statement data is generated.
